(19) United States
(12) Patent Application Publication
(10) Pub. No.: US 2021/0170486 A1
(43) Pub. Date: Jun. 10, 2021

(54) METAL PART, METAL ARTICLE, AND PREPARATION METHOD OF THE METAL PART

(71) Applicant: SHENZHENSHI YUZHAN PRECISION TECHNOLOGY CO., LTD., Shenzhen (CN)

(72) Inventors: YOU-HONG TAN, Shenzhen (CN); CHENG-SHI CHEN, New Taipei (TW)

(21) Appl. No.: 17/033,841

(22) Filed: Sep. 27, 2020

(30) Foreign Application Priority Data
Dec. 9, 2019 (CN) 201911248789.1

(51) Int. Cl. B22F 3/105; B23K 26/03; B22F 3/11

(52) U.S. Cl. CPC B22F 3/1055; B23K 26/032; B33Y 10/00; B22F 2003/1056; B22F 3/11

(57) ABSTRACT

A metal part for an electronic device includes a metal main body and a hole structure located on the metal main body. The hole structure includes a first hole and a second hole intercommunicated with the first hole. A metal article including the metal part and a preparation method of the metal part are also provided.

### FIELD

The subject matter herein relates to a metal part, a metal article including the metal part, and a preparation method of the metal part.

### BACKGROUND

In the field of manufacturing industrial products, it is usually necessary to form composite materials composed of metal and other materials. The composite materials are not mixed together in molecular or atomic level, metal and other materials have their own aggregates, and the two aggregates are combined together by a joint. Such composite materials have the characteristics of both metal and others. However, metals and other materials are different in physical properties, so they cannot be processed and combined by conventional methods such as fusion casting. It is desire to provide a composite technology which can make metal and other materials combined with strong adhesion.

### SUMMARY

To overcome at least one of the above shortcomings, a metal part, a metal article including the metal part, and a preparation method of the metal part are needed.

The present disclosure provides a metal part includes a metal main body and a hole structure. The hole structure is located on the metal main body. The hole structure comprises a first hole and a second hole intercommunicated with the first hole.

The present disclosure also provides a metal article for an electronic device, including a metal part and a material part. The metal part includes a metal main body and a hole structure located on the metal main body. The hole structure includes a first hole and a second hole intercommunicated with the first hole. The material part is embedded in the hole structure.

The present disclosure also provides a preparation method of a metal part. The method includes obtaining a computerized three-dimensional mode of a metal part. At least one slice of the three-dimensional mode is set, a three-dimensional structure of the at least one slice assembles a three-dimensional structure of the three-dimensional mode. The three-dimensional structure of the at least one slice is prepared to form the metal part by using an additive manufacturing method. The metal part includes a metal main body and a hole structure. The hole structure includes a first hole and a second hole intercommunicated with the first hole.

The first hole and the second hole are communicated with each other, which facilitates expelling air when a material slurry such as a plastic melting liquid flows into the first hole and the second hole to combine with the metal part. After the material slurry stereotyped as a material part, the material part in the first hole and the second hole are intercommunicated to form a whole structure, so as to improve the bond strength between the metal part and the material part. The preparation method for preparing the metal part uses the additive manufacturing method to print the at least one slice with three-dimensional structures. Therefore, the structure, sizes, arrangements or other characteristics of the first hole and the second hole of the hole structure can be set according to actual requirements, to allow the first hole and the second hole communicated with each other. In addition, the preparation method of the metal part does not use chemical reagents, and the metal materials for preparing the metal part are unlimited, which can save cost and reduce environmental pollution.

### BRIEF DESCRIPTION OF THE DRAWINGS

Implementations of the present disclosure will now be described, by way of embodiment, with reference to the attached figures.

FIG. 1 is a schematic diagram of a metal part according to some embodiments of the present disclosure.

FIG. 2 is a side view of the metal part of FIG. 1.

FIG. 3 is a schematic diagram of a metal part according to some embodiments of the present disclosure.

FIG. 4 is a side view of the metal part of FIG. 3.

FIG. 5 is a schematic diagram of a metal part according to some embodiments of the present disclosure.

FIG. 6 is a side view of the metal part of FIG. 5.

FIG. 7 is a schematic diagram of a metal article according to some embodiments of the present disclosure.

FIG. 8 is a schematic diagram of a metal article according to some embodiments of the present disclosure.

FIG. 9 is a flow chart of a metal part preparation method according to some embodiments of the present disclosure.

FIG. 10 is a flow chart of a metal article preparation method according to some embodiments of the present disclosure.

### DETAILED DESCRIPTION

The embodiments of the present disclosure will be described clearly and completely below in combination with the accompanying drawings. Obviously, the described embodiment is only part of the embodiments of the present disclosure, not all of the embodiments. Based on the embodiments in the present disclosure, all other embodiments obtained by those skilled in the art without creative labor belong to the protection scope of the present application.

It should be noted that if a component is called “fixed” to another component, it can be directly or indirectly fixed to another component or indirectly fixed to another component by an intermediate component. If a component is considered to “connect” to another component, it can be directly connected to another component or indirectly connected to another component by an intermediate component. When a component is considered to be “arranged” on another component, it can be set directly to another component or indirectly arranged on another component by an intermediate component. The terms “vertical”, “horizontal”, “left”, “right” and similar expressions indicating directions or positions are based on the directions or positions shown in the attached drawings in order to facilitate the description of the embodiment and simplify the description of the invention, rather than indicating or implying that the device or element referred to must have a specific orientation, be constructed and operated in a specific orientation, it cannot be understood as a limitation of the embodiment of the invention.

Unless otherwise defined, all technical and scientific terms used in the present disclosure have the same meanings as those generally understood by those skilled in the technical field of the application. The terms used in the specification of the present application are only for the purpose of description, and are not intended to limit the present application. The term “or/and” used in the present disclosure includes any one of and all combinations of two or more related listed items.

Some embodiments of the present disclosure are described in detail below in combination with the attached drawings. Without conflict, the following embodiments and features in the embodiments may be combined with each other.

In some related techniques, a hole is provided on a surface of a metal part by a chemical etching method or electrochemical oxidation method. A plastic is located in the hole of the metal part by injection molding to improve the bonding strength between the plastic and the metal part. But either chemical etching method or electrochemical oxidation method cannot control the formation the hole, and most of the hole formed by those two methods are not intercommunicated and are micron holes. Those holes cannot improve the bonding strength higher, and residue air in the bottom of those holes cannot release during the injection molding process, which further limits the effect of the combination.

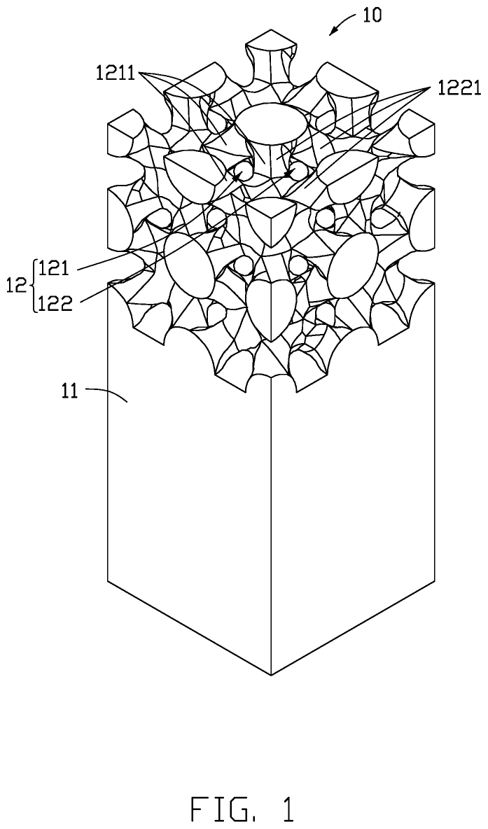

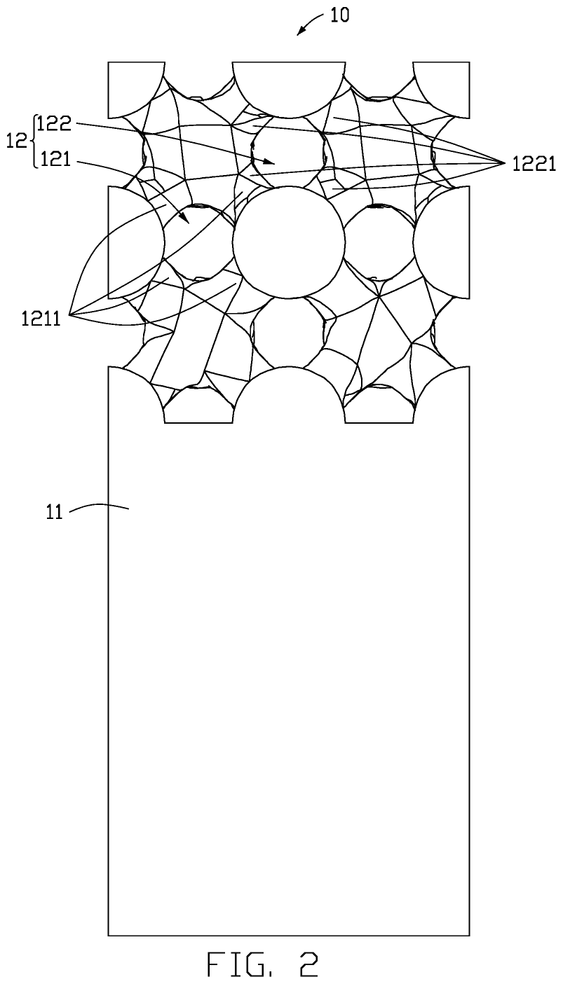

Referring to FIGS. 1 and 2, FIG. 1 is a schematic view of a metal part 10 according to some embodiments of the present disclosure, and FIG. 2 is a side view of the metal part 10.

According to some embodiments, the present disclosure provides the metal part 10 for an electronic device. The metal part 10 includes a metal main body 11 and a hole structure 12 located on the metal main body 11. The hole structure 12 includes a first hole 121 and a second hole 122 intercommunicated with the first hole 121.

The material of the metal part 10 is selected from stainless steel, die steel, titanium alloy and aluminum alloy.

In the illustrated embodiment, the first hole 121 and the second hole 122 have a same shape. The hole structure 12 is formed by the first hole 121 and the second hole 122 to be a three-dimensional ordered structure. That is, the first hole 121 and the second hole 122 are orderly provided in the three-dimensional space to form the hole structure 12.

In the illustrated embodiment, the three-dimensional ordered structure is isotropic. It can be understood, the hole structure 12 may not be completely isotropic at an edge of the metal part 10 due to space limitation. For example, in some embodiments, the edge of the metal part 10 is not a complete hole because the metal part 10 is not enough to arrange an integral number of holes.

Referring to FIG. 2, the first hole 121 and the second hole 122 are arranged orderly in the three-dimensional space, the first hole 121 and the second hole 122 arranged inside is hidden by the first hole 121 and the second hole 122 outside.

In the illustrated embodiment, the first hole 121 and the second hole 122 are formed by a plurality of columns surrounding each other.

The columns comprises N number of first columns 1211 (N≥3) and M number of second columns 1221 (M≥3). The N number of the first columns 1211 surround each other to form the first hole 121. The M number of the second columns 1221 surround each other to form the second hole 122. There is at a first column 1211 coincide with a second column 1221. That is, the first hole 121 is adjacent to the second hole 122, and one column of the first columns 121 is coincide with one column of the second columns 122.

In some embodiments illustrated in FIG. 2, N equals to 4, and M equals to 4.

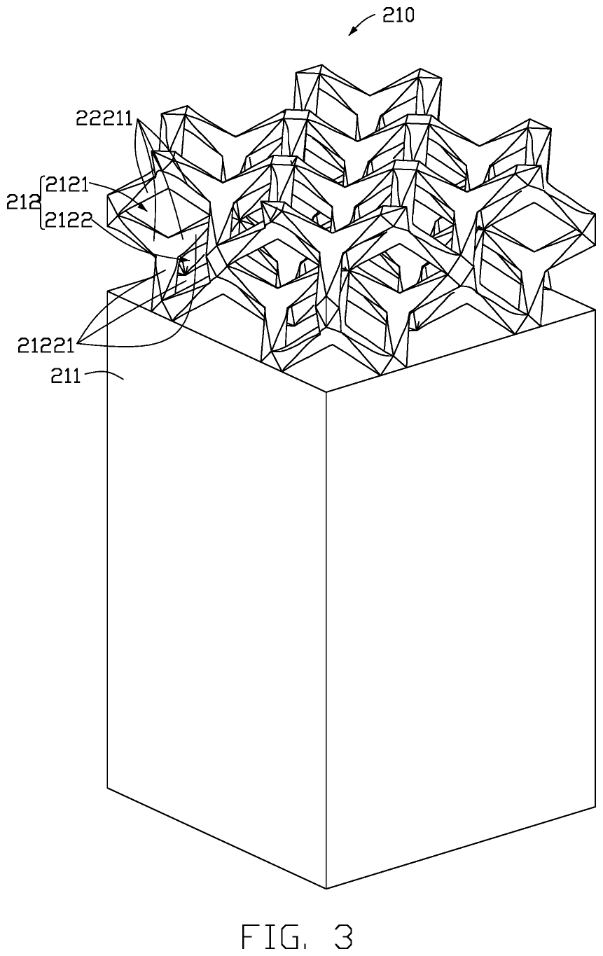

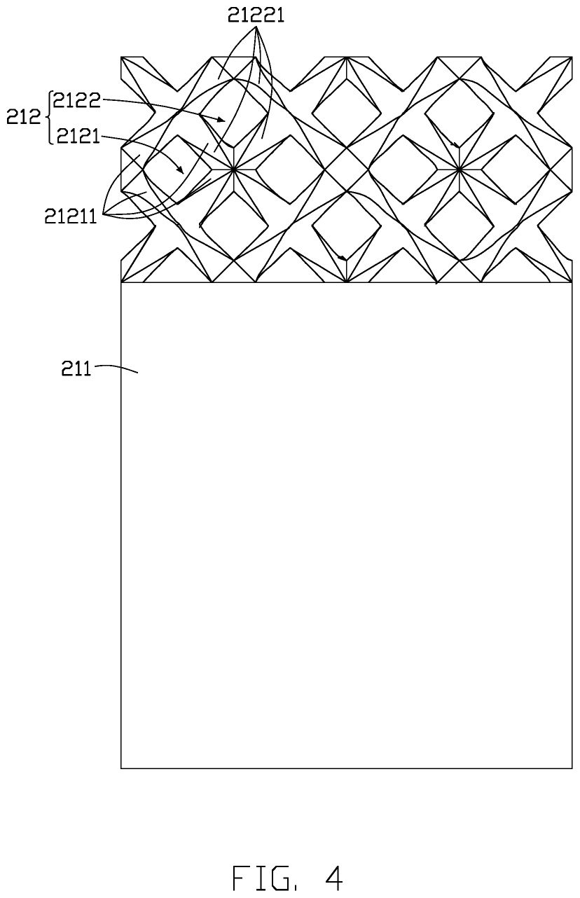

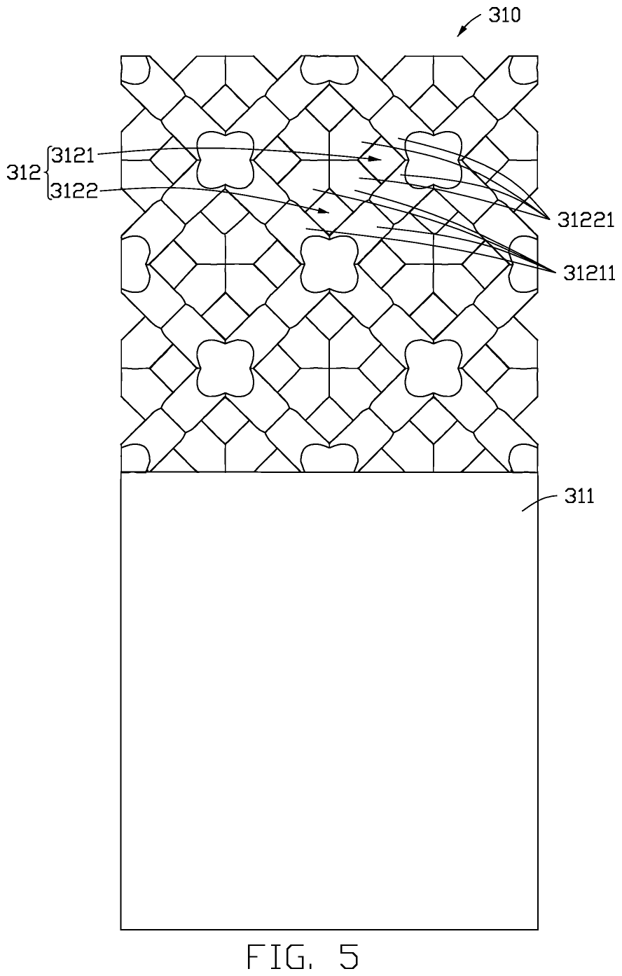

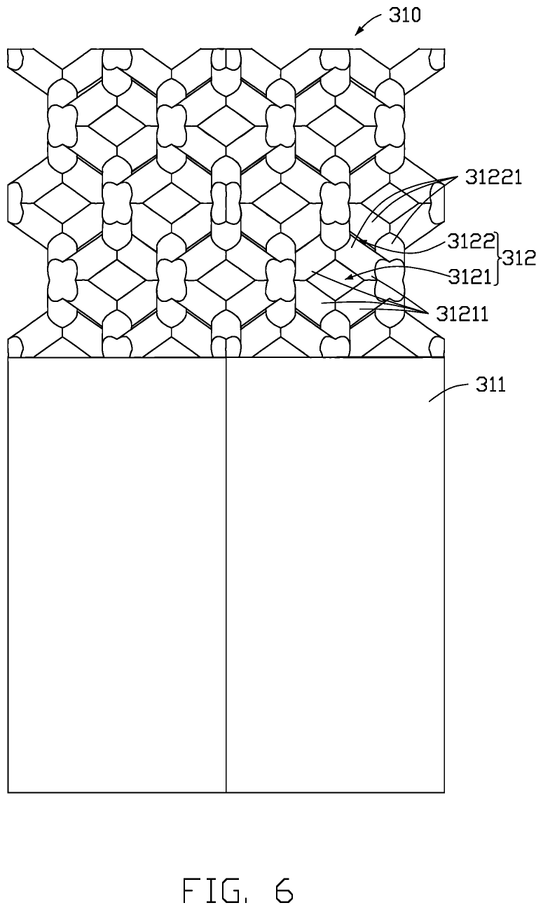

A shape of the first column 1211 and the second column 1221 can be at least one selected from cylinder, polyhedron, and irregular column. In some embodiments illustrated in FIGS. 1 and 2, the shape of the first column 1211 and the second column 1221 are irregular column. Referring to FIGS. 3 and 4, according to some embodiments of the present disclosure, a metal part 210 includes a hole structure 212 consisting of a first hole 2121 and a second hole 2122. First columns 21211 surrounding the first hole 2121 and second columns 21221 surrounding the second hole 2122 are polyhedrons. Referring to FIGS. 5 and 6, according to some embodiments of the present disclosure, a metal part 310 includes a hole structure 312 consisting of a first hole 3121 and a second hole 3122. First columns 31211 surrounding the first hole 2121 and second columns 31221 surrounding the second hole 2122 are cylinders.

The first hole 121 are intercommunicated with the second hole 121, which facilitates expelling air when a material slurry such as a plastic melting liquid flows into the first hole 121 and the second hole 122 to combine with the metal part 10. After the material slurry stereotyped as a material part, the material part in the first hole 121 and the second hole 122 are intercommunicated to form a whole structure, so as to improve the bond strength between the metal part 10 and the material part.

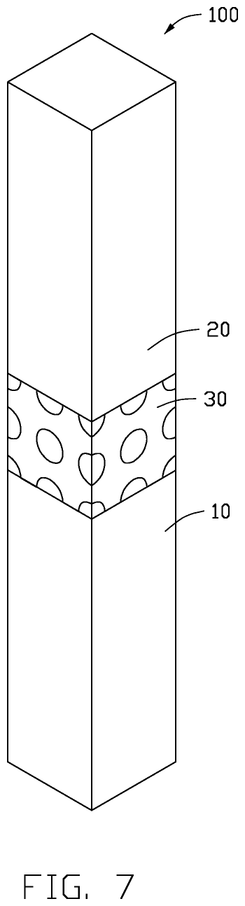

Referring to FIGS. 1, 2 and 7, a metal article 100 is illustrated. The metal article 100 includes the metal part 10 and a material part 20. The metal part 10 is illustrated in some embodiments of FIG. 1. The material part 20 is configured to be at least partly arranged inside the hole structure 12. The material part 20 inside the metal part 10 together with the hole structure 12 to form a bonding zone 30. At the bonding zone 30, the material part 20 and the metal part 10 firmly combined. It should be noted that, in FIG. 7, the bonding zone 30 is shown for illustration only, and it includes parts of the material part 20 arranged inside the metal part 10 and the hole structure 12 of the metal part 10.

The hole structure 12 is formed to be the three-dimensional ordered structure by the first hole 121 and the second hole 122 arranged orderly. That is, the first hole 121 and the second hole 122 are arranged orderly in the three-dimensional space to form the hole structure 12. The three-dimensional ordered structure formed by the first hole 121 and the second hole 122 facilitates evenly distribution of the material part 20 in the hole structure 12, thereby improving bond strength between the metal part 10 and the material part 20 at the bonding zone 30.

The three-dimensional ordered structure is isotropic. It should be noted that, the metal part 10 is in a determined shape, the hole structure 12 may not be completely isotropic at an edge of the metal part 10 due to space limitation. For example, in some embodiments, the edge of the metal part 10 is not a complete hole because the metal part 10 is not enough to arrange an integral number of holes. The three-dimensional ordered structure is isotropic, that is, the hole structure 12 is isotropic. The material part 20 is embedded in the hole structure 12, therefore the material part 20 at the bonding zone 30 is isotropic. Therefore, at the bonding zone 30, the metal part 10 and the material body 20 form an interlocking structure to achieve high bonding strength.

The material part 20 can be made of at least one selected from metal, polymer, ceramic, and glass.

In some embodiments illustrated in FIGS. 1, 2 and 7, the first column 1211 and the second column 1221 of the metal part 10 are irregular columns.

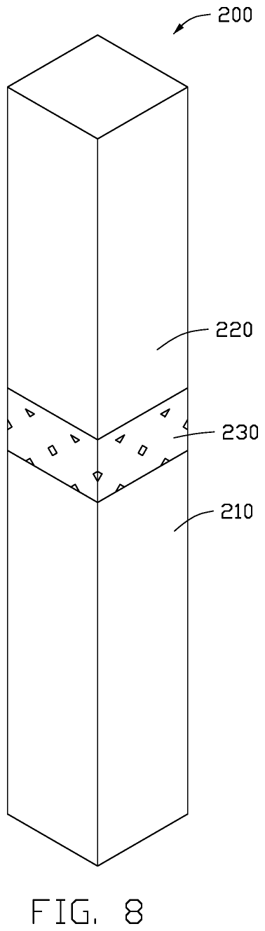

Referring to FIGS. 3, 4 and 8, according to some embodiments of the present disclosure, a metal part 200 includes a metal part 210 and a material part 220. The metal part 210 and the material part 220 define a bonding zone 230. The first column 21211 and the second column 21221 of the metal part 210 are polyhedrons. It should be noted that, the bonding zone 230 is shown for illustration only, and it includes parts of the material part 210 arranged inside the metal part 10 and the hole structure 212 of the metal part 210.

The hole structure 212 is formed to be the three-dimensional ordered structure by the first hole 2121 and the second hole 2122 arranged orderly. That is, the first hole 2121 and the second hole 2122 are arranged orderly in the three-dimensional space to form the hole structure 212. The three-dimensional ordered structure formed by the first hole 2121 and the second hole 2122 facilitates evenly distribution of the material part 220 in the hole structure 212, thereby improving bond strength between the metal part 200 and the material part 220 at the bonding zone 30.

The three-dimensional ordered structure is isotropic. It should be noted that, the metal part 210 is in a determined shape, the hole structure 212 may not be completely isotropic at an edge of the metal part 210 due to space limitation. For example, in some embodiments, the edge of the metal part 210 is not a complete hole because the metal part 210 is not enough to arrange an integral number of holes. The three-dimensional ordered structure is isotropic, that is, the hole structure 212 is isotropic. The material part 220 embedded in the hole structure 12, therefore the material part 220 at the bonding zone 30 is isotropic. Therefore, at the bonding zone 30, the metal part 210 and the material body 220 form an interlocking structure to achieve high bonding strength.

It should be understood that, in other embodiments, the first column and the second column can be cylinders, such as the first column 31211 and the second column 31221 of the metal part 310 shown in FIGS. 5 and 6.

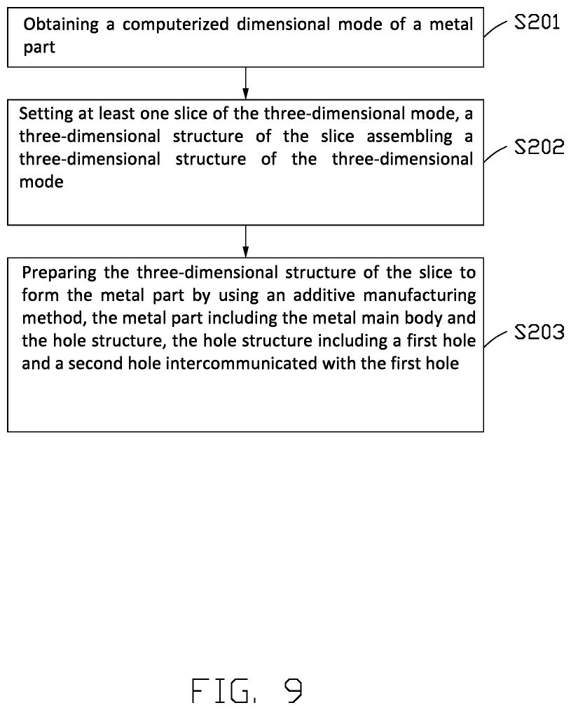

Referring to FIG. 9, a preparation method for preparing a metal part is illustrated. The method includes following blocks.

Block 201, obtaining a computerized dimensional mode of the metal part 10.

Block 202, setting at least one slice of the three-dimensional mode. A three-dimensional structure of slice assembles a three-dimensional structure of the three-dimensional mode.

Block 203, preparing the three-dimensional structure of the slice to form the metal part by using an additive manufacturing method. The metal part 10 includes the metal main body 11 and the hole structure 12. The hole structure 12 includes a first hole 121 and a second hole 122 intercommunicated with the first hole 121.

The additive manufacturing method is one selected from electron beam melting, laser engineered shaping, selective laser melting (SLM) and selective laser sintering.

The material of the metal part 10 is selected from stainless steel, die steel, titanium alloy, aluminum alloy, etc., as long as the metal part 10 can be prepared by the additive manufacturing method.

In at least one embodiment, the material for preparing the metal part 10 can be in a form of metal powder, and a particle size of the metal powder is 10 μm 50 μM.

In at least one embodiment, the additive manufacturing method is SLM. A power range of the laser is 160 w-220 w, a scanning speed range of the laser is 900 mm/s-1400 mm/s, and a scanning distance range of the laser is 0.04 mm-0.1 mm.

In some embodiments, the first hole 121 and the second hole 122 are in the same shape. The hole structure 12 is formed to be the three-dimensional ordered structure by the first hole 121 and the second hole 122 arranged orderly. That is, the first hole 121 and the second hole 122 are orderly provided in the three-dimensional space.

In some embodiments, the three-dimensional ordered structure is isotropic.

In some embodiments, the first hole 121 and the second hole 122 are formed by a plurality of columns surrounding each other.

In the illustrated embodiment, The columns comprises N number of first columns 1211 (N≥3) and M number of second columns 1221 (M≥3). The N number of the first columns 1211 surround each other to form the first hole 121. The M number of the second columns 1221 surround each other to form the second hole 122. There is at a first column 1211 coincide with a second column 1221. That is, the first hole 121 is adjacent to the second hole 122, and one column of the first columns 121 is coincide with one column of the second columns 122.

In the embodiment illustrated in FIG. 2, N equals to 4, and M equals to 4.

A shape of the first columns 1211 and the second columns 1221 can be at least one selected from cylinder, polyhedron, and irregular column.

The preparation method for preparing the metal part uses the additive manufacturing method to print the at least one slice with three-dimensional structures. Therefore, the structure, sizes, arrangements or other characteristics of the first hole 121 and the second hole 122 of the hole structure 12 can be set according to actual requirements, to allow the first hole 121 and the second hole 122 intercommunicated. In addition, the preparation method of the metal part does not use chemical reagents, and the metal materials for preparing the metal part are unlimited, which can save cost and reduce environmental pollution.

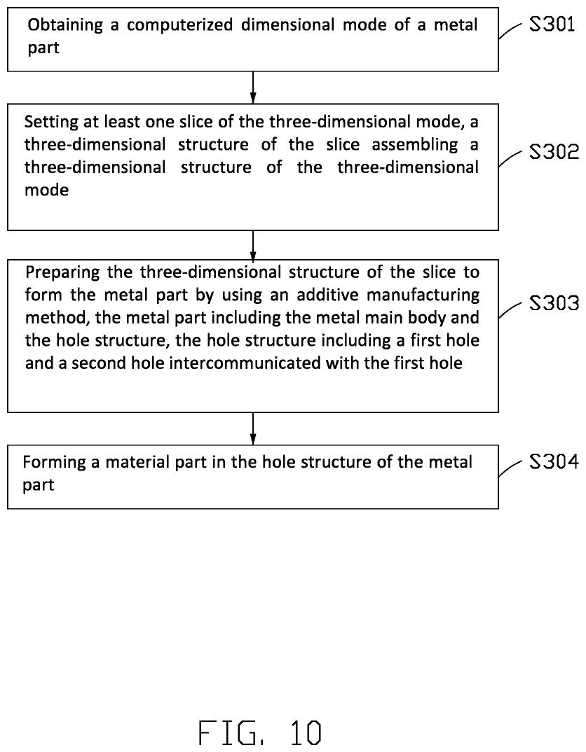

Referring also to FIG. 10, a preparation method for preparing a metal article is illustrated. The metal article 100 includes the metal part 10 and the material part 20. The preparation method for preparing the metal article includes following blocks.

Block 301, obtaining a computerized three-dimensional mode of a metal part 10;

Block 302, setting at least one slice of the three-dimensional mode. A three-dimensional structure of the slice assembles a three-dimensional structure of the three-dimensional mode.

Block 303, preparing the three-dimensional structure of the slice to form the metal part by using an additive manufacturing method. The metal part includes the metal main body 11 and the hole structure 12. The hole structure 12 includes the first hole 121 and the second hole 122 communicated with the first hole 121.

Block 304, forming the material part 20 in the hole structure 12 of the metal part 10.

It should be noted that, the material part 20 can be made of at least one of metal, polymer, ceramic, and glass.

Specifically, in at least one embodiment, the material part 20 is made of plastics.

Preparing the metal part further includes:

Putting the metal part 10 into a mold;

Heating the mold; and

Injecting molten plastics into the mold.

The molten plastics goes into the first hole 121 and the second hole 122. After the mold is cooled, the plastics is combined with the metal part 10 to form the metal part.

The molten plastic enters the first hole 121 and the second hole 122, and is combined with the metal part 10 after cooling.

The shaping method of the material part 20 can be determined according to the material and a state of the material part 20.

For example, if the material part 20 is made of metal and in a form of powder, it can by shaped by laser melting.

For example, if the material of the material part 20 is polymer: if the material part 20 is in a liquid state, it can by shaped by evaporation solvent; if the material part 20 is in a molten state, it can by shaped by injection molding; if the material part 20 is in a molten state, it can by shaped by injection molding; if the material part 20 is in a gas state, it can by shaped by Gas in-situ polymerization.

For example, if the material body 20 is made of ceramic and in a form of powder, it can be shaped by adding adhesive or powder sintering.

For example, if the material body 20 is made of glass: when it is in the form of powder, it can be shaped by heating and then cooling; when the shape is molten, it can be treated by cooling.

The above embodiments are only parts of the present disclosure, and the material and shaping method of the material part 20 are not limited to the above-mentioned embodiments.

It should be noted that, the term metal part is used to distinguish from the term metal part for better understanding only.

It can be understood that ordinary person skilled in the art can make various other corresponding changes and deformations according to the technical concept of the present disclosure, and all such changes and deformations shall belong to the protection scope of the present application.

What is claimed is:

1. A metal part for an electronic device, comprising:
a metal main body; and
a hole structure, located on the metal main body;
wherein the hole structure comprises a first hole and a second hole intercommunicated with the first hole.

2. The metal part according to claim 1, wherein the first hole and the second hole have a same shape, and the first hole and the second hole are provided orderly to form a three-dimensional ordered structure.

3. The metal part according to claim 2, wherein the three-dimensional ordered structure is isotropic.

4. The metal part according to claim 1, wherein the first hole and the second hole are formed by a plurality of columns surrounding each other.

5. The metal part according to claim 4, wherein the plurality of columns comprise N number of first columns and M number of second columns;
wherein the N number of the first columns surround each other to form the first hole, and N≥3; and
the M number of the second columns surround each other to form the second hole, and M≥3.

6. The metal part according to claim 5, wherein the first hole is adjacent to the second hole, and one column of the N number of the first columns is coincide with one column of the M number of the second columns.

7. The metal part according to claim 5, wherein a shape of the first columns and the second columns is at least one selected from cylinder, polyhedron, and irregular column.

8. A metal article for an electronic device, comprising:
a metal part; and
a material part;
wherein the metal part comprises a metal main body and a hole structure located on the metal main body, and the hole structure comprises a first hole and a second hole intercommunicated with the first hole; and
the material part is embedded in the hole structure.

9. The metal article according to claim 8, wherein the material part is made of at least one selected from metal, polymer, ceramic, and glass.

10. The metal article according to claim 8, wherein the first hole and the second hole have a same shape, and the first hole and the second hole are provided orderly to form a three-dimensional ordered structure.

11. The metal article according to claim 10, wherein the three-dimensional ordered structure is isotropic.

12. The metal article according to claim 11, wherein the first hole and the second hole are formed by a plurality of columns surrounding each other.

13. The metal article according to claim 12, wherein the plurality of columns comprise N number of first columns and M number of second columns;
wherein the N number of the first columns surround each other to form the first hole, and N≥3; and
the M number of the second columns surround each other to form the second hole, and M≥3.

14. The metal article according to claim 13, wherein the first hole is adjacent to the second hole, and one column of the N number of the first columns is coincide with one column of the M number of second columns.

15. The metal article according to claim 13, wherein a shape of the first columns and the second columns is at least one selected from cylinder, polyhedron, and irregular column.

16. A preparation method of a metal part, the method comprising:
obtaining a computerized three-dimensional mode of a metal part;
setting at least one slice of the three-dimensional mode, a three-dimensional structure of the at least one slice assembling a three-dimensional structure of the three-dimensional mode; and
preparing the three-dimensional structure of the at least one slice to form the metal part by using an additive manufacturing method, wherein the metal part includes a metal main body and a hole structure, and the hole structure comprises a first hole and a second hole intercommunicated with the first hole.

17. The method according to claim 16, wherein the additive manufacturing method is one selected from electron beam melting, laser engineered net shaping, selective laser melting and selective laser sintering.

18. The method according to claim 16, wherein the additive manufacturing method is selective laser melting.

19. The method according to claim 16, wherein a power of the laser is in a range of 160 w to 220 w, a scanning speed of the laser is in a range of 900 mm/s to 1400 mm/s, and a scanning distance of the laser is in a range of 0.04 mm to 0.1 mm.
